(19) United States
(12) Patent Application Publication
(10) Pub. No.: US 2006/0287921 A1
(43) Pub. Date: Dec. 21, 2006

(54) Acquisition and redistribution of internet access

(76) Inventor: Anthony Defries, Los Angeles, CA (US)

Correspondence Address: Anthony Defries, 1922 Bel Air Road, Los Angeles, CA, 90077, US

(21) Appl. No.: 11/453,096

(22) Filed: Jun. 15, 2006

Related U.S. Application Data
(60) Provisional application No. 60/690,864, filed on Jun. 16, 2005.
(60) Provisional application No. 60/693,445, filed on Jun. 24, 2005.

(51) Int. Cl. G06Q 30/00

(52) U.S. Cl. 705/14

(57) ABSTRACT

The present disclosure concerns methods and systems for Acquisition and Redistribution of Internet Access. In some implementations the method includes acquisition of Internet access and redistribution for marketing, advertising, promotional, branding, dedicated applications, customized platforms, special events or any other purpose including combining or enhancing said access with content and management functions for resale. The method could further include returning a portion of the revenue derived from such use to consumers in the form of cost subsidized redistribution of Internet access. The method could further include the acquisition enhancement, sale and redistribution of Internet access through an auction process that identifies specific factors to establish comparative values.

### RELATED APPLICATIONS

This application claims benefit of and priority to U.S. Provisional Patent Applications No. 60/690,864 filed Jun. 16, 2005 entitled “Method for Redistribution of Bulk Internet Access,” herein incorporated by reference in its entirety and U.S. Provisional Patent Application No. 60/693,445 filed Jun. 24, 2005 entitled “Method to Facilitate Cost Subsidized Redistribution of Internet Access,” herein incorporated by reference in its entirety.

### BACKGROUND

1. Field

The present disclosure concerns Methods and Systems for Acquisition and Redistribution of Internet Access. In some implementations the method includes acquisition of Internet access and redistribution for marketing, advertising, promotional, branding, dedicated applications, customized platforms, special events or any other purpose including combining or enhancing said access with content and management functions for resale. The method could include returning a portion of the revenue derived from such use to consumers in the form of cost subsidized redistribution of Internet access. The method could further include the acquisition enhancement, sale and redistribution of Internet access through an auction process that identifies specific factors in order to establish comparative values.

2. Related Art

Development of network capabilities for computers and computing devices has led to increasing sophistication in the capacity and capability of computer networks. The Internet infrastructure, which permits those networks to be connected, is the subject of constant development and change. Recent innovations have led to the creation of a robust online model for all forms of commercial Internet access and transactions, including business-to-business and business to consumer, government-to-business and government-to-consumer, consumer-to-consumer, marketing. Online advertising has become the fastest growth sector of the marketing/advertising industry. The Internet serves as the major means of delivery for all forms of online marketing, promotion, branding and advertising traffic. Information technologies are fuelling explosive growth in Internet communications and software enterprises.

In the last decade there has been a dramatic increase in Internet use for online marketing, social networking and content distribution. Consumer special interest, dedicated, personal or focus groups of end users have contributed to this growth. There are significant obstacles to acquisition and distribution or redistribution of Internet access and content including technical, technological, financial, social, legal, consensual, privacy, moral, ethical, conceptual and commercial. New models of online marketing and social networking have emerged through the development of hardware and software applications that support information and content distribution. These models have not yet been extended to the area of Internet access provisioning. Substantial benefit would accrue to consumers, content owners, Internet access providers, Internet service providers, commerce, education, health and many other sectors of society by the invention described herein.

Internet access is available by diverse means through connections to Internet service providers or Internet access providers. These providers have a direct physical connection by cable, satellite, wireless or other means to gateways or servers on the Internet and deploy additional facilities or infrastructure to enable consumers to access the Internet. Internet access in this form is frequently provided on a subscriber basis. Internet access distribution is almost entirely in the form of direct sales to end users or Internet service providers. There are no commercially available specialized Internet access or customized content enhancement redistribution schemes incorporating auction sales or other information management functions. No marketing funded online advertising, branding or promotional acquisition and redistribution schemes, whether or not combined with cost subsidized Internet access provisioning to the consumer are commercially available. The methods and systems suggested by the invention described herein would enable these and other new and alternative or improved form and function in connection with the provision, distribution and redistribution of content and Internet access.

This invention concerns a method for content and access distribution and redistribution on the Internet whereby Internet access is acquired from various providers and resold for marketing, advertising, promotional branding and other purposes.

This invention further concerns a method to facilitate cost subsidized redistribution of Internet access by combining and enhancing said access with specialized content and management functions for resale. Internet access could be acquired from various providers and resold for marketing, advertising, promotional, branding, dedicated applications, special events or any other purpose. A portion of the revenue derived from such use could be returned to consumers in the form of cost subsidized redistribution of Internet access.

By way of example an Internet access provider could have multiple subscribers in multiple locations and provide continuous service in multiple geographical territories. Internet access provider could supply continuous service divided into timed segments.

Internet access could be acquired in any combination of these modalities. For example:

by number of subscribers

by demographic grouping of subscribers

by division into discrete time segments

by division into discrete calendar segments

Internet access could be acquired for specific locations or types of locations. An example would be a vehicle, a vessel, a mode of transportation, a structure, a site, a venue, a geographical area, a city, a suburb, a district, a county, a state, a country or a continent or any combination of locations.

Internet access providers could supply different categories of service such as residential, commercial, institutional or otherwise. These could be provided by different methods such as cable, wireless, WiFi, WiMax, satellite, telephone, cellular, power line and others. Service could be supplied in many forms and at different bandwidth rates including narrowband, broadband, DSL, ADSL, ISDN, ISDL et al. Various Internet Protocols could be used for this purpose. Internet access providers could supply free, subsidized or low cost categories of service.

### BRIEF SUMMARY OF THE INVENTION

Internet access could be resold in any combination of the above modalities for marketing, advertising, promotional, branding, special events and any other purpose. This can be achieved by deployment of software and technology to implement management and access functions for control and distribution of the access acquired. Additional content can be acquired, overlaid, inserted, streamed, or otherwise included by any known or obvious means for any purpose. Such content can be controlled, filtered or monitored for quality, continuity, uniformity or other aspects as part of the management and access functions by utilizing automated recursive software programs or other suitable means.

As a method and means to facilitate cost subsidized redistribution of Internet access, this invention could require the organization and management of diverse data and functions, including by way of example:

Grading and Indexing Internet access providers by reference to various factors including: coverage, location, service area, customer demographics, quality of service, installed network infrastructure, bandwidth and throughput rates

Managing and mapping events, locations, sites, demographics, profiling, Internet access and online advertising

Comparative analysis of Internet access provider for quality of service, location, coverage area, demographic customer profile, infrastructure, system data, bandwidth and data throughput rates
Purchase of Internet access
Integration of media or data content management software and/or services
Enhancement of Internet access
Marketing Internet access to online advertisers and others
Management software for monitoring all functions
Analysis software for analyzing all necessary data, systems, sites, applications, equipment and related information
Software Integration
Related management functions for redistribution of Internet access

By way of example, Internet access could be acquired and resold for online advertising purposes through an auction process that identifies specific values and enables interested parties to submit bids based on aggregating those values. These values could include subscriber charges or rates and revenues. Analyzing, weighting and grading a range of different items could establish the comparative value of Internet access. These items could include event values by location and consumer interest, subject matter values by consumer interest demographics, special interest applications, subject matter values by local, regional, national or global significance or interest, application values by subject matter interest.

A platform can be provided for specialized, customized, dedicated or interactive responsive sites.

A platform can be provided for multiple-user/multiple access to said sites.

A platform can be provided to link redistribution of bulk or specific Internet access with specific events, locations and/or applications, to said or particular sites.

A platform can be provided to vendors with unique marketing and branding qualities in the form of proprietary customized Internet access site(s).

Internet access can be sold alone or bundled with some or all or any of the following applications in any combination:

Site management, access services and software.
Data mining, profiling and indexing functions.
Data acquisition and marketing.
Mapping, indexing, grading, managing, and auctioning sites, locations and events.
Online advertising sales.
Enabled universal graphic user interface capabilities to access Internet destinations.
Enabled cross platform front end capabilities to access Internet platforms.
Improved Internet functionality through advanced coding for more efficient data management and network distribution.

In the last decade there has been a dramatic increase in Internet use for online marketing, social networking and content distribution. Consumer special interest, dedicated, personal or focus groups of end users have contributed to this growth. There are significant obstacles to acquisition and distribution or redistribution of Internet access and content including technical, technological, financial, social, legal, consensual, privacy, moral, ethical, conceptual and commercial. New models of online marketing and social networking have emerged through the development of hardware and software applications that support information and content distribution. These models have not yet been extended to the area of Internet access provisioning. Substantial benefit would accrue to consumers, content owners, Internet access providers, Internet service providers, commerce, education, health and many other sectors of society by the invention described herein.

Internet access is available by diverse means through connections to Internet service providers or Internet access providers. These providers have a direct physical connection by cable, satellite, wireless or other means to gateways or servers on the Internet and deploy additional facilities or inffrastructure to enable consumers to access the Internet. Internet access in this form is frequently provided on a subscriber basis. Internet access distribution is almost entirely in the form of direct sales to end users or Internet service providers. There are no commercially available specialized Internet access or customized content enhancement redistribution schemes incorporating auction sales or other information management functions. No marketing funded online advertising, branding or promotional acquisition and redistribution schemes, whether or not combined with cost subsidized Internet access provisioning to the consumer are commercially available. The methods and systems suggested by the invention described herein would enable these and other new and alternative or improved form and function in connection with the provision, distribution and redistribution of content and Internet access.

### BRIEF DESCRIPTION OF THE DRAWINGS

Not Applicable.

### DETAILED DESCRIPTION OF THE INVENTION

An exemplary method of purchasing, acquiring, enhancing, reselling and redistributing Internet access might be enabled by the embodiment and method specifically described herein. Such method could use any or all of the elements identified in this description in any combination, individually or in a plurality of means.

This list of elements is not intended to limit the enabling embodiment(s) in any way. Reference to said elements is intended merely to serve as an indication of significant features and prior art that could be incorporated in the subject invention.
a waveguide, conduit, channel or carrier
a signal
a network
a data stream
a conduit which might be formed of any of plastic/glass/metallic/ceramic/air
a cable which might be coaxial, ethernet, copper wire or power line,
a fiber which might be an optical connection or link
a transmitter
a transponder
a receiver
a transceiver
a broadcast
a narrowcast
a satellite transmission
a laser transmission which might be a focused or non-focused beam using any conduit or carrier
a server
an antenna device
a dish antenna
a modem
a router
a head end
a server
a network hub
a device for transmitting and receiving a signal
an integrated circuit
a microchip
a digital signal processor (DSP)
an integrated wireless transceiver card/chip
a wireless interface card/chip
a network interface card NIC
a network interface device
a node (any single computer or computing device connected to a network)

In a further exemplary embodiment a method to provide subsidized, low-cost or free Internet access to consumers could include performance of some or all of the following steps:

Acquire Internet access or the right to use Internet access from one or more Internet access providers

Market raw Internet access to various acquirers, which could include on-line advertisers, corporate advertisers, corporate brands, event promoters, corporate branding service providers, public relations or marketing organizations and others

Combine or enhance the acquired Internet access or some portion of it with new data, content, software, applications and/or control or management functions

Market the combined or enhanced Internet access to various acquirers, which could include on-line advertisers, corporate advertisers, corporate brands, event promoters, corporate branding service providers, public relations or marketing organizations and others

Donate the combined or enhanced Internet access to an event or entity at a reduced cost or at no cost

Redistribute the combined or enhanced Internet access to one or more Internet access provider

Provide for one or more Internet access provider to supply said Internet access to consumers at a reduced cost or at no cost.

In an alternative exemplary embodiment the method includes performing the operation of the following steps:

Acquire a signal.

Demodulate or modulate the signal on to a carrier conduit or channel which is in communication with a device or devices that contain the means to add content or data to said signal.
Encode or encrypt a stream of bits as digital data
Decode or decrypt a stream of bits as digital data.
Combine said bit stream with one or more encoded digital data streams
Combine said bit stream with a plurality of digital data content in whatever form.
Mix the combined data or bit stream with digital data for insertion of content.
Change, insert or replace data content on the carrier conduit or channel.
Change, insert or replace data content at the network interface card or device.
Change, insert or replace data content or display or identification in any portion of the network or any network interface device.
Demodulate or modulate this enhanced signal onto a conduit or channel
which forms part of an Internet access network
which has access to the Internet
which can be operated by an Internet access provider
which can be remotely addressed
which can be remotely programmed
which can be automated
which can be switched
which can be refreshed or repeated
which can be interrupted
which can be continuous
which can be discontinuous
which can be monitored

Manage, monitor, control, filter, distribute and analyze said signal on said conduit or channel.

The foregoing means, method and marketing strategies are described as an exemplary embodiment of the invention. This example is intended to demonstrate that any of the aforementioned steps could be used alone or in conjunction with any other and in the sequence described or in any other sequence.

Additional means for enhancement of Internet access could include multiple-user/multiple access environments and/or sites. Additional content for enhancement of Internet access could include data in any form including, but not limited to, visual images, graphic images, computer generated visual or graphic images, animation or simulation whether or not computer generated, interactive media access of any description including single player or multi player games, video, audio, software applications and software programs.

It will be apparent to any of those persons who are knowledgeable and skilled in the art that the aforementioned description is merely one example of a possible method of enabling the invention described. This description is not intended in any way to limit or exclude alternative embodiments or uses of the invention. All and any forms or embodiments or uses of the invention are considered to be addressed and taught by the methods and descriptions illustrated and contained herein.

It is also understood that the examples and implementations described herein are for illustrative purposes only and that various modification or changes in light thereof will be suggested to persons skilled in the art and are to be included within the spirit and purview of this application and scope of the appended claims and combinations thereof.

What is claimed is:

1. A method for content and access distribution and redistribution on the Internet whereby Internet access is at least acquired and at least resold for marketing, advertising, promotional, branding and other purposes, so as to include some or all of the following steps:
where Internet access is acquired in any combination of modalities including at least by number of subscribers, by demographic grouping of subscribers, by division into discrete time segments, by division into discrete calendar segments,
where Internet access is acquired for specific locations or types of locations including at least, a vehicle, a vessel, a mode of transportation, a structure, a site, a venue, a geographical area, a city, a suburb, a district, a county, a state, a country, a continent or any combination of locations,
where different categories of Internet service are acquired including at least residential, commercial, or institutional,
where such services are provided by different methods, including at least, wireless, WiFi, WiMax, satellite, telephone, cellular, power line and others,
where such services are supplied in many forms and at different bandwidth rates including at least narrowband, broadband, DSL, ADSL, ISDN, ISDL and others,
where various Internet Protocols are used for such services including at least free, subsidized or low cost categories of such service.

2. The method of claim 1, for content and access redistribution or resale whereby Internet access is at least acquired and at least resold for marketing, advertising, promotional, branding and other purposes including at least any combination of modalities of marketing, advertising, promotional, branding, special events or other purposes, so as to include some or all of the following:
where software and technology are deployed to at least implement management and access functions for least control and distribution of the access acquired,
where additional content is at least acquired, overlaid, inserted, streamed or at least included or combined with the access acquired by any known or obvious means for any purpose,
where such content can at least be controlled, filtered or monitored for at least quality, continuity, or uniformity as part of at least the management and access functions by at least automated software programs or other means,
to at least facilitate cost subsidized redistribution of Internet access by at least combining and enhancing said access with at least specialized content and management functions for resale,
to at least acquire Internet access from various providers and at least resell such access for marketing, advertising, promotional, branding, dedicated applications, special events or any other purpose,
to at least return at least a portion of the revenue derived from such use to consumers in the form of cost subsidized redistribution of Internet access,
to provide at least a platform for at least specialized, customized, dedicated or interactive responsive sites,
to provide at least a platform for at least multiple-user/multiple access to said sites,
to provide at least a platform to at least link redistribution of bulk or specific internet access with specific events, locations and/or applications to said or particular sites,
to provide at least a platform to at least vendors with unique marketing and branding qualities in the form of at least proprietary customized Internet access site(s),
to at least donate combined or enhanced Internet access to an event or entity at a reduced cost or at no cost.
to at least redistribute combined or enhanced Internet access to at least one or more Internet access providers,
to at least provide for at least one or more Internet access provider to supply at least said Internet access to consumers at a reduced cost or at no cost.

3. The method of claim 1 for redistribution of Internet access which includes at least the organization and management of diverse data and functions so as to include some or all of the following steps:
grading and indexing Internet access providers by reference to various factors including at least coverage, location, service area, customer demographics, quality of service, installed network infrastructure, bandwidth and throughput rates,
managing and mapping at least events, locations, sites, demographics, profiling, Internet access and online advertising,
making a comparative analysis of Internet access providers for at least quality of service, location, coverage area, demographic customer profile, infrastructure, system data, bandwidth and data throughput rates,
at least acquiring Internet access,
at least acquiring media or data content,
integration of at least management software and services for at least media access or data content,
enhancement of at least Internet access, media access or data content,
marketing Internet access to at least online advertisers and others,
the use of at least management software for monitoring all functions,
the use of at least analysis software for analyzing at least data, systems, sites, applications, equipment and related information,
the use of at least software integration,
the use of at least related management functions for at least redistribution of Internet access.

4. A method and system for acquisition and redistribution of Internet access by means of an auction process that identifies specific values and enables interested parties to submit bids based on aggregating those values which system may comprise the following means:
where said values could at least include Internet access providers subscriber charges, rates or revenues,
where said values could include at least Internet access provider subscriber charges, comparative value of Internet access, event location and consumer interest.
where said values could include at least consumer interest demographics, special interest applications, subject matter values by local, regional, national or global significance or interest, application values by subject matter interest.
where Internet access is sold alone or bundled with various applications including at least site management, access service, software, data mining, profiling and indexing functions.
where Internet access is sold alone or bundled with various applications including at least data acquisition, marketing, mapping, indexing and grading.
where Internet access, media access or data content are sold alone or in any combination with at least various applications including managing and auctioning sites, locations, events and online advertising sales.
where Internet access is sold alone or bundled with various applications including at least enabled graphic user interface capabilities to access Internet destinations.
where Internet access is sold alone or bundled with various applications including at least enabled cross platform front end capabilities to access Internet platforms,
where Internet access is sold alone or bundled with various applications including at least improved Internet functionality through advanced coding for more efficient data management and network distribution.

5. The method of claim 4 for acquisition, enhancement and redistribution of Internet access, media access or data content which includes at least marketing said access or content, alone or in any combination by the following means:
public or private marketing by auction or any other method using any media including at least, electronic, telephonic, direct response, online, Internet, direct exchange, mail, broadcast, dedicated networks or other platforms,
marketing by any method using any media including at least, search engines, browsers, communication systems, shared networks, social networks, private networks, virtual private networks, dedicated access networks, multiuser or multisite interactive response sites.

6. A means to at least acquire, at least enhance and at least distribute an Internet access signal by demodulating or modulating said signal onto any conduit or channel, using some or all of the following steps:
where the conduit or channel forms at least part of an Internet access network or has at least access to the Internet,
where the conduit or channel is at least operated by an Internet access provider, at least remotely addressed, at least remotely programmed, automated, switched, refreshed, repeated, interrupted, continuous, discontinuous, monitored, or in any other mode,
where the conduit or channel is at least formed of any of plastic, glass, metallic, ceramic, air, coaxial cable, Ethernet, copper wire or power line,
where the conduit or channel includes at least a fiber, an optical connection or link, a transmitter, a transponder, a receiver, a transceiver, a broadcast, a narrow cast, a satellite transmission, a laser transmission,
where the conduit or channel includes at least an antenna, a modem, a router, a network hub, a head end, a node or a network interface device in any other form, to at least manage, monitor, control, filter, distribute and analyze said signal on said conduit or channel.

7. The means of claim 6 to at least enhance, change, or add content to an Internet access signal and at least distribute said signal by the operation of some or all of the following steps:
acquire at least a signal,
demodulate or modulate said signal on to at least a carrier conduit or channel which is in communication with at least a device or devices that contain at least the means to add content or data to said signal,
at least encode or encrypt at least a stream of bits as digital data,
at least decode or decrypt at least a stream of bits as digital data,
combine at least said bit stream with at least one or more encoded digital data streams
combine at least said bit stream with at least a plurality of digital data content in whatever form,
mix at least the combined data or bit stream with digital data for at least insertion of content,
at least change, insert or replace data content on at least the carrier channel or conduit,
at least change, insert or replace data content at the network interface card or device,
at least change, insert or replace data content, display or identification in at least any portion of the network or at any network interface device.
